(19) United States
(12) Patent Application Publication
(10) Pub. No.: US 2012/0275466 A1
(43) Pub. Date: Nov. 1, 2012

(54) SYSTEM AND METHOD FOR CLASSIFYING PACKETS

(75) Inventors: Sandeep BHADRA, Addison, TX (US); Jing-Fei REN, Plano, TX (US); Manish GOEL, Plano, TX (US)

(73) Assignee: TEXAS INSTRUMENTS INCORPORATED, Dallas, TX (US)

(21) Appl. No.: 13/278,296

(22) Filed: Oct. 21, 2011

Related U.S. Application Data
(60) Provisional application No. 61/405,494, filed on Oct. 21, 2010.

(51) Int. Cl. H04L 12/56

(52) U.S. Cl. 370/419

(57) ABSTRACT

A system and method for classifying packets in a communication network. In one embodiment a packet routing device includes a Bloom filter array and a content-addressable memory (CAM). The Bloom filter array includes a plurality of Bloom filters configured to process a packet in parallel. Each of the Bloom filters is configured to determine whether the packet includes a predetermined attribute. The CAM is coupled to the Bloom filter array. The CAM is configured to assign the packet to an output port of the routing device based on attributes of the packet determined by the Bloom filter array.

### CROSS-REFERENCE TO RELATED APPLICATION

The present application claims priority to U.S. Provisional Patent Application No. 61/405,494, filed on Oct. 21, 2010 (Attorney Docket No. TI-70149PS); which is hereby incorporated herein by reference in its entirety.

### BACKGROUND

Conventional routers, switches, and other packet routing devices used to route data over the Internet or other data networks typically match, and forward, packets based on media access control (MAC) or internet protocol (IP) (Network Layer) addresses contained in the packets. A conventional network may have a line speed of, for example, 10 gigabits/second (Gbps), 40 Gbps, etc. Using software to look up the routing for packets on such a network may be infeasible due to constraints in the speed of fetching data from memory for processing. For this reason, look up of packet routing information is often implemented via a hardware lookup table.

A wide variety of potential networking applications may benefit from fast packet classification based on information other than MAC and IP addresses. Therefore, new techniques for fast packet classification that allow packets to be routed based on a broad range of packet information are desirable.

### SUMMARY

A system and method for classifying packets in a communication network is disclosed herein. In one embodiment a packet routing device includes a packet classifier including a Bloom filter array and a content-addressable memory (CAM). The Bloom filter array includes a plurality of Bloom filters configured to process a packet in parallel. Each of the Bloom filters is configured to determine whether the packet includes a predetermined attribute. The CAM is coupled to the Bloom filter array. The CAM is configured to assign the packet to an output port of the routing device based on attributes of the packet determined by the Bloom filter array.

In another embodiment, a method includes providing at least a portion of a packet to an array of Bloom filters. The array of Bloom filters processes the packet in parallel using a plurality of Bloom filters. The Bloom filters determine attributes of the packet. A content addressable memory (CAM) identifies an output port to which to direct the packet based on the attributes determined by the Bloom filters.

In yet another embodiment, a network includes a packet routing device. The packet routing device includes a Bloom filter array and a ternary content addressable memory (TCAM) coupled to an output of the Bloom filter array. The Bloom filter array includes a plurality of counting Bloom filters arranged in parallel. Each of the Bloom filters is configured to determine whether a packet received by the routing device possesses a predetermined attribute. The TCAM is configured to determine, based on attributes of the packet identified by the Bloom filters, an output port of the packet routing device to be used for forwarding the packet.

In a further embodiment, a packet routing device includes a look-up engine and a ternary content-addressable memory (TCAM). The look-up engine is configured to process a packet and to determine whether the packet includes one or more predetermined attributes. The TCAM is coupled to the look-up engine. The TCAM is configured to assign the packet to an output port of the routing device based on attributes of the packet determined by the look-up engine.

### BRIEF DESCRIPTION OF THE DRAWINGS

For a detailed description of exemplary embodiments of the invention, reference will now be made to the accompanying drawings in which:

FIG. 1 shows a block diagram of a communication network including a routing device that classifies packets in accordance with various embodiments;

FIG. 2 shows an exemplary representation of a Bloom filter in accordance with various embodiments;

FIG. 3 shows a block diagram of a routing device that classifies packets in accordance with various embodiments; and

FIG. 4 shows a flow diagram for a method for classifying packets in a communication network in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regard less of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Some networking applications can benefit from packet routing based on information contained in headers or data positioned above protocol layer 3 (i.e., above the network layer). Providing quality of service (QoS) in wireless gateways, cloud networking, adaptive video congestion, and intrusion detection are examples of such applications. Application of QoS to different classes of traffic (video, voice, P2P, HTTP, FTP, etc.) in wireless gateways may be employed by network operators to manage their wireless networks and mitigate the effects of increasing wireless data traffic on limited wireless spectrum. Measurement of traffic-type is a related problem that requires classification of heterogeneous traffic into traffic types prior to packet-counting.

Cloud networking refers to emerging networking virtualization and Infrastructure services that offer multi-tenant information processing in virtual machines (VMs) and networking across VMs, over a common set of servers and top-of-rack (ToR) routers. Networking of ToRs efficiently to minimize inter-VM congestion, or server heating, and maximize load-balancing is an emerging area of systems research and development. Packet flows from one VM to another may be tagged with proprietary VM-tags. Providing ToR flow tables based on these VM tags may simplify network design and free cloud networking from the underlying physical internet protocol (IP)/media access control (MAC) network topology.

Adaptive video congestion control methodologies are based on selective frame discard techniques that distinguish between I, P and B frames in encoded video (e.g., a H.264 encoded video), and optimize perceived video quality by preferentially dropping B frames over P frames, and P frames over I frames. I, P and B frames in encoded video can be parsed based on string signatures in the packet that identify the packet type.

Intrusion detection and prevention systems (e.g., SNORT) rely upon byte-string signatures to detect suspicious traffic. Rapid packet classification supports parsing matching signatures at line rate.

Embodiments of the present disclosure provide the ability to quickly and efficiently classify packets based on information carried at protocol layers 4-7 and/or non-Internet Engineering Task Force (IETF) specific tags. Thus, embodiments facilitate the above-mentioned, and numerous other technologies that benefit from fast packet classification based on information contained in any protocol layer of a packet.

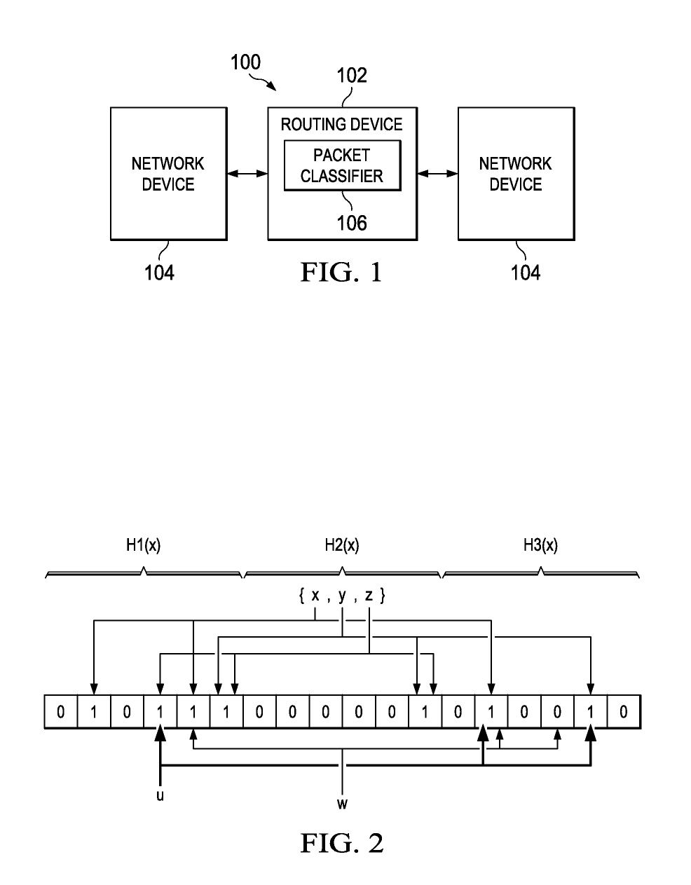

FIG. 1 shows a block diagram of a communication network 100 including a routing device 102 that classifies packets in accordance with various embodiments. The network 100 includes a plurality of network devices 104 that communicate via the routing device 102. Though only two network devices 104 are shown in FIG. 1, in practice the communication network 100 may include any number of network devices 104. The network device 104 may be any of a wide variety of devices configured to access a communication network. For example, the network device 104 may be a laptop computer, a desktop computer, a tablet computer, a server, a wireless handset, a gaming system, etc. The network device 104 may communicate with another network device 104 connected to the network 100, or with network devices 104 connected to different networks via the routing device 102. Consequently, the routing device 102 may be coupled to additional networks not shown in FIG. 1.

The routing device 102 may be a router, a switch, a gateway, or any other device configured to route packets within a communication network and/or across communication networks. The routing device 102 receives packets transmitted by the network device 104 (of the network 100 or a different network), and determines an output port of the routing device 102 to be used to forward the packet towards its ultimate destination. The routing device 102 includes a packet classifier 106 that facilitates identification of an appropriate output port based on various information contained in the packet, including information other than MAC and IP addresses. For example, the packet classifier 106 may categorize a packet and select an output port for the packet based on information included in protocol layers 4-7 of the packet in addition to information contained at lower protocol levels.

To improve routing speed, conventional routing devices may implement a hardware lookup table using a Content Addressable Memory (CAM). A CAM is a hardware block which can perform a binary string match against a programmed set of binary CAM entries and return the index of the matching pre-programmed string in the CAM. Some CAMs can also perform wildcard matches over a ternary alphabet {0, 1,*}. Such CAMs are referred to as ternary CAMs (TCAMS). TCAMs are particularly effective for implementing multiple IP addresses and masks in routing tables (for instance a range of consecutive binary strings from 1011000-1011111 can be represented by one ternary entry 1011***). Unfortunately, TCAMs are expensive and consume substantial amounts of power. Searching for variable sized, variable location, potentially non-IETF tags in a TCAM requires a very wide TCAM. Moreover, as the number and types of headers included in a packet increase, and multi-header rules become more complex, a flow table implemented in the TCAM becomes very large making direct lookup via the TCAM prohibitively expensive in terms of cost and/or power.

Embodiments of the packet classifier 106 avoid the use of such expensive and unwieldy TCAMs by including an array of Bloom filters ahead of the TCAM. The Bloom filters identify the attributes of a received packet, and provide the attribute information to a TCAM configured to select an output port for the packet based not solely on address information extracted from the packet, but on the attributes of the packet identified by the Bloom filters.

A Bloom filter includes of an array of N bits each initially set to 0, and a set of k hash functions. Each hash function f_i( )has a range from 0 to N-1. An element x is added to the Bloom filter as follows: The hash functions f_1(x), f_2(x) . . . f_k(x) are calculated and the bits of the Bloom filter bit array at locations f_1(x), f_2(x) . . . f_k(x) are set to 1. This procedure is repeated until a predetermined number of elements have been added to the Bloom filter. Once configured, the Bloom filter can be used to determine whether an element w is a member of the set of elements which have been added to the Bloom filter. To make this determination, the Bloom filter calculates f_1(w), f_2(w) . . . f_k(w) and checks to see whether the bits at those locations in the array of bits of the Bloom filter are set to 1. If the bits at the calculated locations are set, then w is a member of the set, and if the bits are not set, then w is not a member of the set.

FIG. 2 shows an exemplary Bloom filter for the set {x, y}. As shown in FIG. 2, array bits at positions corresponding to the application of designated hash functions to the x, y, and z are set. Applying the hash functions to w identifies w as lacking membership in the set {x, y, z} (i.e., the hash of w indexes a zero value in the Bloom filter bit array).

While useful for determining set membership, Bloom filters are not without weaknesses. Under some conditions, a Bloom filter can return a false positive indication. That is, a Bloom filter may falsely indicate that an element is a member of a set. In FIG. 2, u is not a member of the set, and yet the Bloom filter indicates set membership. Furthermore, elements can only be added to a Bloom filter. Elements cannot be removed so as to avoid disturbing the membership of other elements sharing bit locations. For example, in FIG. 2, y and z share the 6th bit in the Bloom filter bit array.

Embodiments of the packet classifier 106 mitigate these deficiencies of Bloom filters by including an array of parallel Bloom filters. The array of parallel Bloom filters significantly reduces the probability of generating a false positive. For example, in an embodiment of the packet classifier 106 include an array of five parallel Bloom filters returning {no, no, yes, yes, yes} to a membership query, the membership determination based on these results is “no” because a Bloom filter can return false positives but cannot return false negatives.

While Bloom filters as defined above can be used to add elements, it is not possible to remove an element from a Bloom filter without disturbing other elements. Instead, counting Bloom filters may be used to both add and delete elements. Counting Bloom filters include a ‘reference counter’ associated with each bit in the Bloom filter—the reference counter tracks the number of elements that refer to the particular bit in the filter. When an element is hashed to a particular bit in the array, the reference counter is incremented by 1. When an element is removed from the Bloom filter, the reference counter associated with each bit of the element is decremented by 1. When the reference counter is decremented down to 0, this implies that no element references that particular bit, and thus the bit in the array itself is reset to 0.

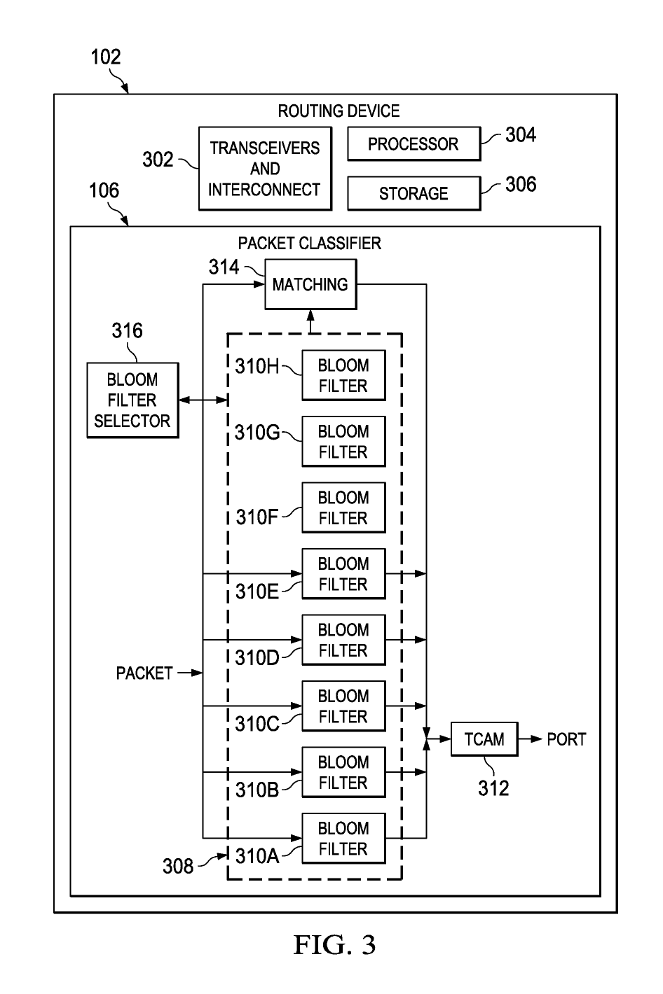

FIG. 3 shows a block diagram of the routing device 102 that classifies packets in accordance with various embodiments. The routing device 102 includes transceivers and interconnect 302, a processor 304, storage 306, and the packet classifier 106. The transceivers may be configured to receive and transmit data in accordance with a predetermined networking standard. The interconnect is a system for transferring packets between the transceivers, and may include a system of switches and conductors (e.g., a crossbar) that provide a packet transfer path between each of the transceivers.

Packets received by a transceiver are provided to the packet classifier 106. The packet classifier 106 matches the packet and selects an output port to which the packet is transferred for forwarding to the next destination in the network 100. The routing device 102 and the packet classifier may support any number of ports, where a port refers to a logical channel having a set of predetermined characteristics or attributes applied to the transfer of packets via the channel. For example, different ports may apply a different quality of service or performance attributes (e.g., latency, error rate, delivery guarantee, etc.) to the packets transferred through the port.

The packet classifier 106 includes an array of Bloom filters 308 and a TCAM 312. The array of Bloom filters includes a plurality of Bloom filters 310 (designated 310A-H in FIG. 3) arranged in parallel. While the Bloom filter array 308 is illustrated as including eight Bloom filters 310, embodiments are not limited to any particular number of Bloom filters 310. Each Bloom filter 310 may be a counting Bloom filter. A packet received by the routing device 102, or a portion of the received packet, is provided to each of the Bloom filters 310, or to a selected plurality of the Bloom filters 310. The rules applied to the packet by the Bloom filters 310 may be complex multi-header rules, and may be represented as Boolean expressions in Disjunctive/Conjunctive Normal Form. For example, disparate routing conditions or attributes assessed by the Bloom filters 310 may be based on headers, tags, and/or strings of the packet as follows:

Condition A: Packets from a specified IP address (e.g., 192.168.23.134);

Condition B: Packets transferred using user datagram protocol (UDP); and

Condition C: Packets that include a particular header (e.g., MPEG).

The packet classifier 106 combines individual conditions, such as those described above, to construct complex multi-header rules. Each such logical combination of conditions is termed a clause. For example, with reference to the exemplary conditions described above:

Clause (A

[symbol]

### B′

C): Packets from IP address 192.168.23.134 that are non-UDP and contain an MPEG header; and

Clause (A′

[symbol]

### B

C′): Packets not from IP address 192.168.23.134 that are UDP and contain no MPEG header.

By establishing an ordered set of conditions, the packet classifier 106 may represent the clauses described above as binary strings “101” and “010” respectively. For “don't care” conditions the ternary symbol “*” may be used. For example, the Clause (A

[symbol]

C) may be represented as “1*1.” For a large list of conditions, clauses may consist largely of the ternary symbol *.

Each Bloom filter 310 may be configured to recognize a condition or a set of non-overlapping conditions. The TCAM 312 is configured to recognize each clause (i.e., each set of conditions or attributes established by the Bloom filters 310). For each received packet, the incoming bit string is replicated into parallel identical streams—one for each Bloom filter 310. A condition match (0,1) corresponding to (no, yes) is provided by each Bloom filter 310 and the packet attribute determinations of the Bloom filter array 308 are provided to the TCAM 312 which performs a lookup of the clause (i.e., the packet attribute combination) and provides an output port address for the packet.

For example, with reference to the conditions described above, Bloom filter 310A may be configured to identify banned UDP header strings, Bloom filter 310B may be configured to identify IP header strings corresponding to banned IP addresses, and Bloom filter 310C may be configured to identify an acceptable content string (such as an MPEG header). The TCAM 312 may be configured to only allow flows from a set of acceptable IP addresses with acceptable UDP headers of type MPEG to a predetermined port. Thus, the packet classifier 106 determines how to route a packet based on the attributes of the packet as determined by the Bloom filter array 308. The TCAM 312 does not contain entries corresponding to the packet strings that define the packet attributes, but rather contains a condensed representation of multiple string memberships corresponding to the packet attributes identified by the Bloom filter array 308.

The packet classifier 106 may also include means to identify and processes packets and/or attributes of a packet likely to generate false positive indications in the Bloom filters 310 configured to identify packet attributes. In some embodiments of the packet classifier 106, a Bloom filter (e.g., 310F) is configured to identify packet attributes that generate a false positive indication in another Bloom filter (e.g., 310A). When the bit string generating the false positive indication is processed in the Bloom filter array 308, both the Bloom filter 310A and the Bloom filter 310F output a positive indication. The packet classifier 106 may process the packet or the suspect bit string in a matching block 314 which may implement a deterministic string match in software or hardware to accurately identify the attribute(s) of the packet.

In place of the Bloom filter array 308, some embodiments of the packet classifier 106 include one or more other types of look-up engines. The look-up engines process a packet received by the routing device 102, or a portion of the received packet, and, like the Bloom filter array 308, provide indications (e.g., Boolean, {yes, no} indications) of the packet attributes to the TCAM 312. Embodiments of a look-up engine may include hash-tables, binary trees, sorted look-up tables, etc. The look-up engine may apply rules (e.g., complex multi-header rules) to the headers, tags, strings, etc. of the received packet. The rules may be represented as Boolean expressions in Disjunctive/Conjunctive Normal Form for identification of packet routing conditions, packet attributes, etc. The TCAM 312 does not contain entries corresponding to the packet strings that define the packet attributes, but rather contains a condensed representation of multiple string memberships corresponding to the packet attributes identified by the look-up engine. The TCAM 312 is configured to recognize each clause (i.e., each set of conditions or attributes established by the look-up engine). The TCAM 312 performs a lookup of the clause (i.e., the packet attribute combination) and provides an output port address for the packet. Other operations of embodiments of the classifier 106 that includes a look-up engine are as described with regard to the embodiments include Bloom filter array 308.

Some embodiments of the packet classifier 106 identify packet headers that cause false positives, and rebalance the Bloom filter array 308 by removing some conflicting elements from one Bloom filter 310 and adding those elements to another Bloom filter 310. The rebalancing reduces the probability of the same header producing false positives in the future.

The packet classifier 106 also includes a Bloom filter selector 316. The Bloom filter selector 316 manages the Bloom filters 310 by adding or removing bloom filters in the set of Bloom filters 310. In some embodiments, the Bloom filter selector 316 evaluates the activity level of the set of Bloom filters 310 being used to determine packet attributes. If the activity level exceeds a predetermined upper threshold, then the Bloom filter selector 316 may activate (e.g., power up) additional Bloom filters 310 to perform packet attribute identification. Thus, the Bloom filter selector 316 dynamically adds processing capacity to the Bloom filter array 308 based on an activity level of the active Bloom filters 310; at other times the Bloom filter selector 316 saves power by powering down unused Bloom filters. The activity level of the Bloom filters may be determined based on the number of elements hashed into each Bloom filter 310 or other performance criteria (such as probability of false positives). Thus, the Bloom filter selector 316 minimizes the power consumed by the Bloom filter array 308 by powering individual Bloom filters 310 only when needed. The number of active Bloom filters 310 does not affect the width of the TCAM 312.

Various components of the wireless device 102 including at least some portions of the packet classifier 106 can be implemented using a processor executing software programming that causes the processor to perform the operations described herein. For example, in some embodiments of the packet classifier 106, the matching block 314 and/or the bloom filter selector 316 may include a processor executing software programming that causes the processor to examine the bit strings of a packet to determine the attributes of the packet in situations where a Bloom filter 310 may generate a false positive indication.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming that causes a processor to perform the operations disclosed herein can be stored in a computer readable storage medium. A computer readable storage medium comprises volatile storage such as random access memory, non-volatile storage (e.g., a hard drive, an optical storage device (e.g., CD or DVD), FLASH storage, read-only-memory), or combinations thereof.

Some embodiments of the routing device 102 may implement portions of the packet classifier 106, including portions of the Bloom filters 310 and the TCAM 312 using dedicated circuitry (e.g., dedicated circuitry implemented in an integrated circuit). Some embodiments may use a combination of dedicated circuitry and a processor executing suitable software. For example, some portions of the Bloom filter selector 316 may be implemented using a processor or hardware circuitry. Selection of a hardware or processor/software implementation of embodiments is a design choice based on a variety of factors, such as cost, time to implement, and the ability to incorporate changed or additional functionality in the future.

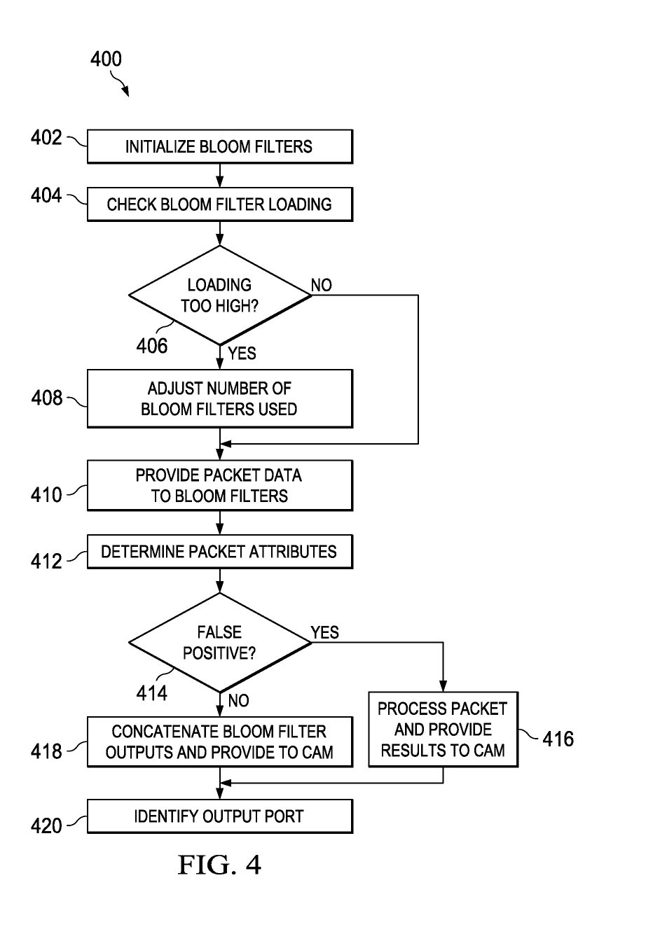

FIG. 4 shows a flow diagram for a method 400 for classifying packets in a routing device 102 in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 400, as well as other operations described herein, can be performed by the packet classifier 106. In the method 400, the routing device 102 is operating in the communication network 100 to forward packets received from network devices 104 towards their ultimate destinations.

In block 402, the routing device 102 initializes the Bloom filters 310 and the TCAM 312. The set of Bloom filters 310 of the Bloom filter array 308 is initialized to recognize the attributes of a received packet based on the various bit strings of the packet contained in the packet headers and/or data. The initialization may include setting bits in the Bloom filter bit array in accordance with results of application of a hash function to packet bit string values indicative of an attribute or condition to be identified by the Bloom filter 310. The TCAM 312 is initialized to assign an output port to each combination of packet attributes identified by the Bloom filters 310.

In block 404, the routing device 102 checks the loading of Bloom filters 310 assigned to determine the attributes of the packet. Some embodiments may determine the level of loading by comparing the number of elements hashed into each Bloom filter 310 against a predetermined threshold. If the Bloom filters 310 loading is determined to be too high in block 406, then the number of Bloom filters 310 assigned to determine packet attributes is adjusted in block 408. A Bloom filter 310 may be added to the plurality of Bloom filters 310 used to identify packet attributes by applying power to the previously unpowered circuitry of the Bloom filter 310 and initializing the bit array of the newly powered Bloom filter 310 to identify one or more selected packet attributes.

In block 410, the packet or a portion thereof is replicated and provided to each of the Bloom filters 310 assigned to packet examination. The Bloom filters 310 process the packet, in block 412, and each Bloom filter 310 determines whether the packet includes one or more attributes by hashing the appropriate portions of the packet and comparing the results to the bit array of the Bloom filter 310.

In block 414, the routing device 102 determines whether the Bloom filters 310 may have produced a false positive attribute indication. The determination may be based on the output of a Bloom filter 310 configured to identify packet bit strings that may produce false positive indications in a different Bloom filter 310. If a possible false positive condition is identified, then the packet, or a portion of the packet, may be deterministically processed by the matching block 314 to determine one or more packet attributes in block 416. In some embodiments, the packet attributes identified by the matching block 314 (e.g., binary attribute flags), alone or in combination with those identified by the Bloom filters 310, are provided to the TCAM 312.

In block 418, the outputs of the Bloom filters 310, e.g., binary attribute state flags that identify attributes of the packet being processed are concatenated to form a condition clause (e.g., an attribute bit string). The condition clause includes information regarding all of the packet attributes examined by the Bloom filters 310. The condition clause is provided to the TCAM 312.

In block 420, the TCAM 312 searches its stored condition clause entries for an entry corresponding to the condition clause provided by the Bloom filters 310 and/or the matching block 314. The TCAM 312 outputs a port identifier corresponding to the received condition clause and the routing device 102 forwards the packet to the port identified by the TCAM for transfer to a next destination.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A packet routing device, comprising:
a Bloom filter array comprising a plurality of Bloom filters configured to process a packet in parallel, each of the Bloom filters configured to determine whether the packet includes a predetermined attribute; and
a content-addressable memory (CAM) coupled to the Bloom filter array; wherein the CAM is configured to assign the packet to an output port of the routing device based on attributes of the packet determined by the Bloom filter array.

2. The packet routing device of claim 1, wherein the attributes of the packet determined by the Bloom filter array are grouped to form a data value provided as input to the CAM.

3. The packet routing device of claim 1, wherein the CAM is a ternary CAM.

4. The packet routing device of claim 1, wherein the Bloom filter array comprises a given Bloom filter configured to determine whether the packet includes an attribute identified to generate a false positive indication from a different one of the Bloom filters of the Bloom filter array.

5. The packet routing device of claim 4, further comprising a packet matching block configured to determine attributes of the packet in lieu of the Bloom filter array responsive to the given Bloom filter and the different one of the Bloom filters generating a positive indication for the packet.

6. The packet routing device of claim 1, wherein the Bloom filter array comprises a selector sub-system configured to control the number of Bloom filters of the plurality of Bloom filters.

7. The packet routing device of claim 6, wherein the selector sub-system is configured to:
determine a level of loading of the plurality of Bloom filters; and
switch power to an additional Bloom filter, thereby adding the additional Bloom filter to the plurality of Bloom filters, based on the loading level of the plurality of Bloom filters exceeding a predetermined threshold.

8. The packet routing device of claim 6, wherein a width of the CAM remains constant as a number of Bloom filters in the plurality of Bloom filters changes.

9. The packet routing device of claim 1, wherein the Bloom filters are counting Bloom filters.

10. The packet routing device of claim 1, wherein the Bloom filter array is configured to move an attribute determination from a first Bloom filter to a second Bloom filter based on the attribute determination contributing to a false positive indication generated by the first Bloom filter.

11. The packet routing device of claim 1, wherein the Bloom filter array is configured to determine attributes of the packet based on information contained in layers above the network layer of the packet.

12. A method, comprising:
providing at least a portion of a packet to an array of Bloom filters;
processing the packet in parallel by the array of Bloom filters;
determining, by the array of Bloom filters, attributes of the packet;
identifying, by a content addressable memory (CAM), an output port to which to direct the packet based on the attributes determined by the array of Bloom filters.

13. The method of claim 12, further comprising:
generating a data value by concatenating an output of each of the Bloom filters identifying an attribute of the packet; and
providing the data value to the CAM for use in the identifying of an output port.

14. The method of claim 12, wherein the CAM is a ternary CAM and the Bloom filters are counting Bloom filters.

15. The method of claim 12, further comprising:
initializing a false positive identification Bloom filter in the array of Bloom filters; and
determining, by the false positive identification Bloom filter, whether the packet includes an attribute identified to generate a false positive indication from a different one of the Bloom filters of the array of Bloom filters.

16. The method of claim 15, further comprising determining attributes of the packet using an alternative packet matching block in lieu of the array of Bloom filters responsive to the false positive identification Bloom filter determining that the packet includes the attribute identified to generate the false positive indication.

17. The method of claim 12, further comprising changing a number of Bloom filters of the array of Bloom filters used to process packets based on a loading level of the Bloom filters.

18. The method of claim 17, wherein changing the number of Bloom filters comprises:
determining a loading level of the array of Bloom filters;
switching power to an additional Bloom filter, thereby adding the additional Bloom filter to the Bloom filters used to process packets, based on the loading level of the Bloom filters used to process packets being determined to exceed a threshold.

19. The method of claim 12, further comprising moving an attribute determination from a first Bloom filter of the array of Bloom filters to a second Bloom filter of the array of Bloom filters based on the attribute determination contributing to a false positive indication generated by the first Bloom filter.

20. A network, comprising:
a packet routing device, comprising:
a Bloom filter array comprising a plurality of counting Bloom filters arranged in parallel; and
a ternary content addressable memory (TCAM) coupled to an output of the Bloom filter array;
wherein each of the Bloom filters is configured to determine whether a packet received by the routing device possesses a predetermined attribute; and
wherein the TCAM is configured to determine, based on attributes of the packet identified by the Bloom filters, an output port of the packet routing device to be used for forwarding the packet.

21. The network of claim 20, further comprising a plurality of devices communicating via the network through the packet routing device.

22. The network of claim 20, wherein the Bloom filter array comprises a given Bloom filter configured to determine whether the packet includes an attribute identified to generate false positive indication from a different one of the Bloom filters of the Bloom filter array; and the packet routing device comprises a packet matching block configured to determine attributes of the packet in lieu of the Bloom filter array responsive to the given Bloom filter and the different one of the Bloom filters generating a positive output for the packet.

23. The network of claim 20, wherein the packet routing device comprises a Bloom filter selector configured to control a number of Bloom filters of the plurality of counting Bloom filters based on a loading level of the plurality of counting Bloom filters; and wherein the selector sub-system is configured to:
determine the loading level of the plurality of counting Bloom filters; and
switch power to an additional Bloom filter, thereby adding the additional Bloom filter to the plurality of counting Bloom filters, based on the loading level of the plurality of counting Bloom filters being determined to exceed a threshold.

24. The network of claim 20, wherein the packet routing device is configured to move an attribute determination from a first Bloom filter to a second Bloom filter based on the attribute determination contributing to a false positive output generated by the first Bloom filter.

25. A packet routing device, comprising:
a look-up engine configured to process a packet and to determine whether the packet includes one or more predetermined attributes; and
a ternary content-addressable memory (TCAM) coupled to the look-up engine; wherein the TCAM is configured to assign the packet to an output port of the routing device based on attributes of the packet determined by the look-up engine.

26. The packet routing device of claim 25, wherein the look-up engine comprises one or more look-up elements selected from a group consisting of a plurality of hash tables, a plurality of binary trees, a plurality of sorted lookup tables, and a plurality of Bloom filters.

27. The packet routing device of claim 26, further comprising a selector configured to control a number of the look-up elements of the look-up engine based on a loading level of the look-up engine; and wherein the selector is configured to:
determine the loading level of the look-up engine; and
switch power to an additional look-up element, thereby adding the additional look-up elements to the look-up engine, based on the loading level of the look-up engine being determined to exceed a threshold.

28. The packet routing device of claim 25, wherein the TCAM is incapable of interpreting strings of the packet.
